(19) United States
(12) Patent Application Publication
(10) Pub. No.: US 2007/0277417 A1
(43) Pub. Date: Dec. 6, 2007

(54) Cover for paper clips

(76) Inventor: James B. Babcock, White Hall, MD (US)

Correspondence Address: Royal W. Craig;Ober, Kaler, Grimes & Shriver, 120 East Baltimore Street, Baltimore, MD, 21202-1643, US

(21) Appl. No.: 11/807,828

(22) Filed: May 30, 2007

Related U.S. Application Data
(60) Provisional application No. 60/809,078, filed on May 30, 2006.

(51) Int. Cl. G09F 3/16

(52) U.S. Cl. 40/666

(57) ABSTRACT

A paper clip cover bearing printed indicia such as decorative or informational content that can be affixed to a sheaf of documents and function as a standard paper clip while displaying the information contained on the cover to the recipient of the documents. Three embodiments are disclosed including one with a front section and a back strip attached end-to-end across the front section to form a pocket for receiving a prong of the paper clip. Another embodiment simply has two slits cut into the paper cover to form an intermediate tab, and no backing. A third embodiment has two full sheets of paper glued together, with multiple paper clip covers defined by perforations through the sheets. In this case the user can print the sheets in a standard office printer with desired decoration, and punches them out.

### CROSS-REFERENCE TO RELATED APPLICATION(S)

The present application derives priority from U.S. Provisional Application No. 60/809,078 filed May 30, 2006.

### BACKGROUND OF THE INVENTION

(1) Field of the Invention

The present invention generally relates paper clips and specifically to providing a decorative and/or informational cover for the paper clip.

(2) Description of Prior Art

Conventional paper clips succeed at binding papers together, but despite their prominent placement they have no aesthetic of informational value. On the other hand, attaching any decorative or ornamental covering tends to obstruct the binding function of the paper clip.

There are a number of exemplary patents in this area. U.S. Pat. No. 5,870,802 to Goldman shows a wire clip wrapped in a banding that allows display of printed information and the like.

U.S. Pat. No. 6,327,749 to Antinones shows a cover for a standard binder clip that can function also as a money clip.

U.S. Pat. No. 4,951,408 to Banks shows a tab marker with a clear cover that is attached to one end of a paper clip that can display information and the like.

The present invention allows the user an intuitively simple and very cost-effective way to add a decorative or informative covering to a conventional wire paper clip and retain all the original function of the standard paper clip.

### SUMMARY OF THE INVENTION

It is therefore, an object of this invention to equip a conventional wire paperclip with a decorative or informative covering without impeding the original function of the paper clip.

These and other objects are accomplished herein by a paper clip cover that overcomes the limitations of existing designs and methods.

The invention is a paper clip cover comprising a die-cut paper front section and a die-cut paper backing adhered to the front section so that a pocket is formed to allow a standard paper clip to be inserted. The front section may bear printed indicia such as decorative or informational content. The assembled cover and clip can then be affixed to a sheaf of documents and function as a standard paper clip while displaying the indicia contained on the cover to the recipient of the documents.

Another embodiment of the invention simply has two slits cut into the cover to form an intermediate tab, and no backing. The standard paper clip is then slid onto the tab created by the two slits. The assembled cover and clip can then be affixed to a sheaf of documents and function as a standard paper clip while displaying the information contained on the cover to the recipient of the documents.

A third embodiment of the invention has two full sheets of paper glued together, with the laminating adhesive masked in certain areas. Slits are cut at these masked areas through one sheet only to form a pocket and a plurality of a desired shape is perforated through both sheets around the slits. The user then prints the sheets in a standard office printer with desired decoration, punches out each cover using the perforations and assembles a paper clip into the pocket formed by the slits. The assembled cover and clip can then be affixed to a sheaf of documents and function as a standard paper clip while displaying the information contained on the cover to the recipient of the documents.

Other variations and advantages are described in the detailed description below.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front view of a preferred embodiment.

FIG. 2 is a rear view of a preferred embodiment.

FIG. 3 is perspective view of a preferred embodiment, functioning as intended.

FIG. 4 is a front view of another preferred embodiment.

FIG. 5 is a rear view of another preferred embodiment.

FIG. 6 is perspective front view of another preferred embodiment, functioning as intended.

FIG. 7 is a rear perspective view of another preferred embodiment.

FIG. 8 is a front perspective view of another preferred embodiment.

FIG. 9 is a rear perspective view of a full sheet of covers.

FIG. 10 is a perspective front view of another preferred embodiment, functioning as intended.

### DETAILED DESCRIPTION OF THE PREFERRED EMBODIMENTS

The present invention is a simple and very cost-effective paper clip cover for adding a decorative or informative covering to a conventional wire paper clip and yet retain all the original function of the standard paper clip.

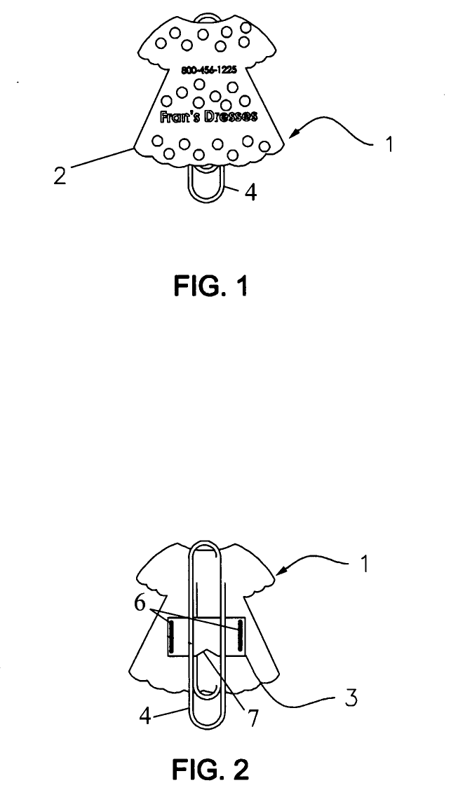

FIG. 1 is a front view of a preferred embodiment of a paper clip cover 1 according to the present invention, and FIG. 2 is a rear view. Referring collectively to FIGS. 1 and 2, the paper clip cover 1 comprises a front section 2 that is fixably attached a backing 3 (FIG. 2), where backing 3 comprises a horizontal strip attached to front section 2 only along its side margins 6 (by glue lines or the like) so as to form a lateral pocket between backing 3 and front section 2. This way, one prong of a conventional paperclip 4 can be slidably attached by the user into the pocket behind the backing 3 as shown in FIG. 1 and FIG. 2. Note that the lower edge of backing 3 is defined by convergent angular V-notch 7. The V-notch is preferably a die cut isosceles triangle extending inward toward the opposing edge, and a right triangle is suitable. The paper backing 3 is adhered end-to-end across the front section 2 by a pair of vertical glue lines 6 proximate the opposing ends, and confined thereto so as not to obstruct insertion of the paper clip 4.

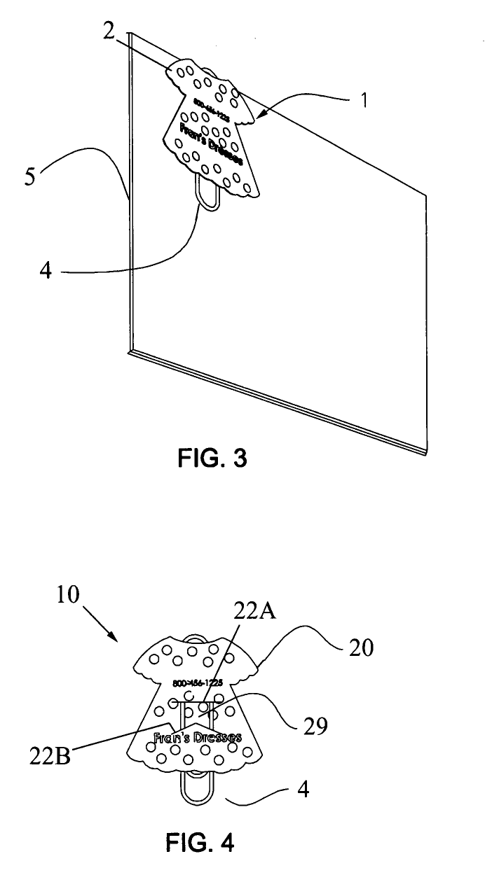

Once the assembly of front section 2, backing 3 and paper clip 4 is formed, the user can then apply the assembly as a standard paperclip and retain a sheaf of documents 5 in a desired arrangement as shown in FIG. 3. The convergent angle of V-notch 7 allows documents 6 to slide smoothly all the way into paperclip 4. Without the V-notch 7 (with parallel edges) documents 5 would catch edgewise and prevent the smooth engagement of paper clip 4 over documents 5. The front section 2 preferably bears printed, embossed or laminated indicia such as advertising, instructions or decoration.

Referring again to FIG. 2. it is shown that backing 3 is cut with V-notch 7 at a convergent angle so as to allow documents 5 to slide smoothly all the way into paperclip 4, since there are no parallel edges of backing 3 to catch on documents 5. The paper clip 4 with cover 2 smoothly engages over documents 5.

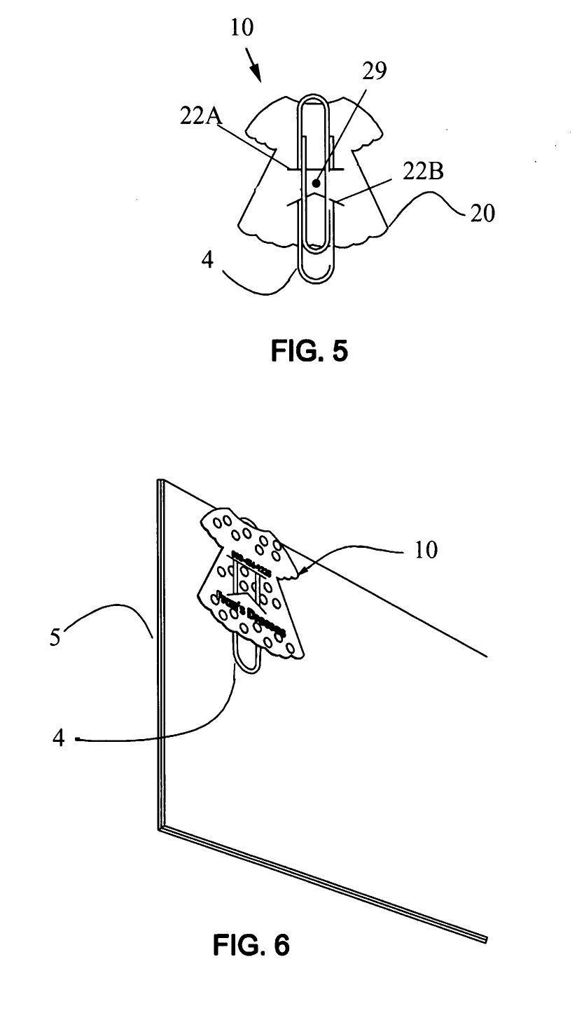

FIG. 4 and FIG. 5 show an alternative embodiment of a paper clip cover 10 where a front section 20 is cut with a pair of lateral slits 22A, 22B that form a pocket 29 wherein one prong of paperclip 4 can be slidably attached by the user into said pocket 29 as shown. The lower slit 22B is likewise formed with convergent angles oriented toward the upper slit 22A (as an inverted V) to allow documents 5 to slide smoothly all the way into paperclip 4. Since there are no parallel edges of pocket 29 to catch on documents 5, they slide smoothly edgewise into paper clip 4. This embodiment 10 has the advantage of being made of a single piece of material for ease and economy of manufacture. Once the assembly of front section 20 and paper clip 4 is formed, the user can then apply the assembly as a standard paperclip and retain a sheaf of documents 5 in a desired arrangement as shown in FIG. 6. Here again the advantages of the invention over a standard paperclip are clear, as the cover may contain advertising, instructions or decoration.

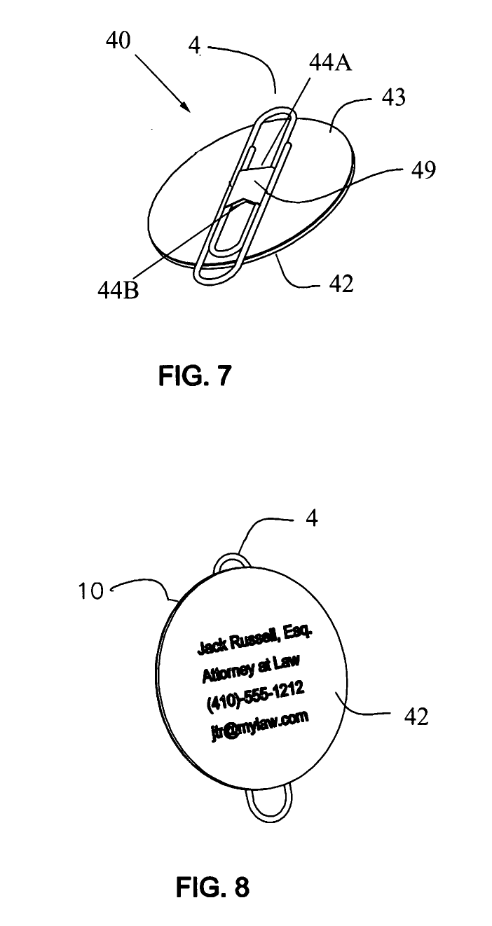

FIG. 7 and FIG. 8 show another alternative embodiment of a paper clip cover 40 where a front section 42 is laminated to a dimensionally-conforming backing 43 to form a two-ply lamination. Just the backing 43 is cut with a pair of lateral slits 44A, 44B that form a pocket 49 wherein one prong of paperclip 4 can be slidably attached by the user into said pocket 49 as shown. The lower slit 44B is again formed with convergent angles oriented toward the opposing slit 44A (inverted V) to allow documents 5 to slide smoothly all the way into paperclip 4 without catching on (parallel) edges of pocket 49. The documents 5 slide smoothly edgewise into paper clip 4.

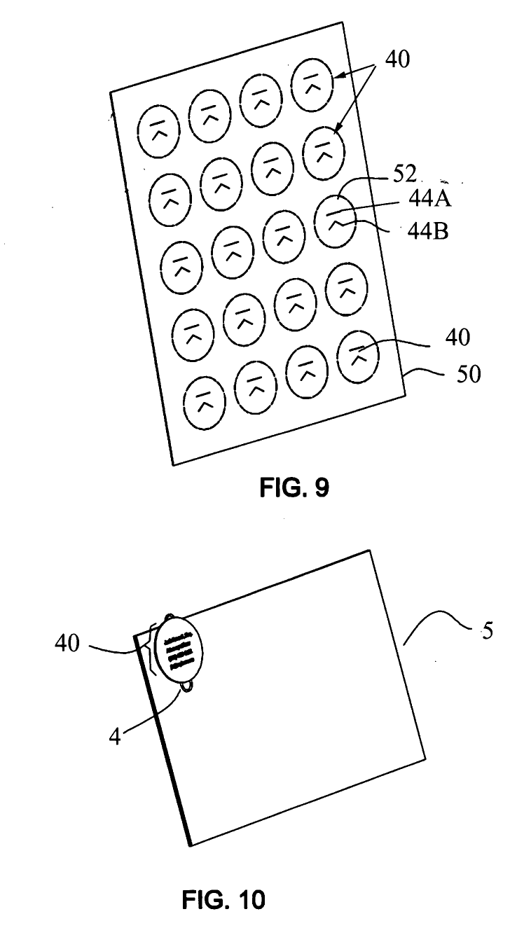

As seen in FIG. 9, this embodiment is advantageous as it can be made as part of a full sheet 50 of paper clip covers 40, each one defined by punch-out perforations 52. This way, a user can feed the sheet 50 through a standard office printer or copier to produce custom printed paper clip covers 40. The custom printed covers 40 may then be removed from sheet 50 by the user tearing the lamination at perforations 52 that define the shape of the plurality of covers 40 contained in sheet 50. This has the advantage of easy customization by the user and minimal inventory for the manufacturer, as no special printing will be performed except by the user. Once the assembly of the cover 40 and paper clip 4 is formed, the user can then apply the assembly as a standard paperclip and retain a sheaf of documents 5 in a desired arrangement as shown in FIG. 10. Here once more the advantages of the invention over a standard paperclip are clear, as the cover may contain advertising, instructions or decoration.

It should now be apparent that the foregoing provides multiple embodiments of an intuitively simple and very cost-effective decorative or informative covering to a conventional wire paper clip that retains all the original function of the standard paper clip.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

What is claimed is:

1. A paper clip cover, comprising:
a thin front section;
a backing strip adhered end-to-end across said front section to form a pocket to receive a conventional paper clip,
whereby said paper clip cover can be attached to said paper clip by insertion of a prong of said clip into said pocket, and the combination paper clip cover and clip can then be affixed to a sheaf of documents while displaying the print indicia to the recipient of the documents.

2. The paper clip cover according to claim 1, wherein said backing strip has a top edge and a bottom edge, the bottom edge being defined by an inwardly converging notch.

3. The paper clip cover according to claim 1, wherein said die-cut paper backing strip is formed as an elongate rectangular strip.

4. The paper clip cover according to claim 3, wherein said paper backing strip is adhered end-to-end across said front section by a pair of vertical glue lines proximate opposing ends.

5. The paper clip cover according to claim 1, wherein said notch is formed as an isosceles triangle.

6. A paper clip cover, comprising:
a thin section, said thin section having two opposing lateral slits cut there through to form a pocket extending across said paper section to receive a conventional paper clip,
whereby said paper clip cover can be attached to a conventional paper clip by insertion of a prong of said clip into said pocket, and the combination paper clip cover and clip can then be affixed to a sheaf of documents while displaying the print indicia to the recipient of the documents.

7. The paper clip cover according to claim 6, wherein said opposing lateral slits include an upper slit spaced from a lower slit, and the lower slit is formed with an angle.

8. The paper clip cover according to claim 7, wherein said upper lateral slit is straight and the lower slit is formed as inverted V.

9. A paper clip cover, comprising:
a thin front section;
a thin back section conforming to said front section and adhered thereto, said thin back section having two opposing lateral slits cut there through to form a pocket extending across said back section to receive a conventional paper clip,
whereby said paper clip cover can be attached to a conventional paper clip by insertion of a prong of said clip into said pocket, and the combination paper clip cover and clip can then be affixed to a sheaf of documents while displaying the print indicia to the recipient of the documents.

10. The paper clip cover according to claim 9, wherein said opposing lateral slits include an upper slit spaced from a lower slit, and the lower slit is formed with an angle.

11. The paper clip cover according to claim 10, wherein said upper lateral slit is straight and the lower slit is formed as inverted V.

12. A plurality of paper clips according to claim 9, all integrally formed in a laminated sheet and defined by punch-out perforations.
